(19) United States
(12) Patent Application Publication
(10) Pub. No.: US 2015/0240711 A1
(43) Pub. Date: Aug. 27, 2015

(54) CONNECTING ROD STRUCTURE OF ENGINE

(71) Applicant: Mazda Motor Corporation, Aki-gun (JP)

(72) Inventors: Yasunori Kanda, Hiroshima-shi (JP); Tsunehiro Mori, Aki-gun (JP); Masatoshi Nitta, Aki-gun (JP); Masaru Ishikawa, Aki-gun (JP)

(21) Appl. No.: 14/617,085

(22) Filed: Feb. 9, 2015

(30) Foreign Application Priority Data
Feb. 26, 2014 (JP) 2014-035125

(51) Int. Cl. F02B 75/32; F16C 7/00

(52) U.S. Cl. CPC F02B 75/32; F16C 7/00

(57) ABSTRACT

A connecting rod structure includes a connecting rod for coupling a crankshaft to a piston, the connecting rod including a larger end part formed with a shaft insertion hole for the crankshaft, a smaller end part formed with a pin insertion hole for a piston pin which couples the piston to the smaller end part, and a coupling part for coupling the larger end part to the smaller end part; and a dynamic absorber provided to the larger end part for suppressing the piston, the piston pin, and the connecting rod from integrally resonating with respect to the crankshaft. The dynamic absorber includes a fixed part fixed to the larger end part and a supporting part for coupling the fixed part to a mass part and supporting the mass part to be movable in substantially longitudinal directions of the connecting rod with respect to the fixed part.

### BACKGROUND

The present invention relates to a connecting rod structure of an engine, and particularly to a technique in which a smaller end part of a connecting rod is coupled to a piston by a piston pin and a larger end part of the connecting rod is coupled to a crankshaft, and which suppresses vibration caused by the piston, the piston pin, and the connecting rod resonating together.

Generally, in engines installed in vehicles (e.g., automobiles), a piston is coupled to one end part (smaller end part) of a connecting rod by a piston pin, and the other end part (larger end part) of the connecting rod is coupled to a crankshaft. The smaller and larger end parts of the connecting rod are coupled to each other by a coupling part of the connecting rod. Further, reciprocation of the piston is transmitted to the crankshaft via the connecting rod, so as to rotate the crankshaft.

Such engines are known to cause combustion noises due to resonance which occurs depending on a basic structure of the engine (e.g., see Masaya Otsuka, “How to Minimize Diesel Combustion Noise by Improving Engine Structure,” Proceedings of Society of Automotive Engineers Convention, No. 36-05, Society of Automotive Engineers of Japan, Inc., May 2005, P.7-10). Further, rapid combustion, caused in diesel engines and engines in which premixed compression self-ignition combustion (HCCI: Homogeneous-Charge Compression-Ignition combustion) is performed, amplifies vibrations in frequency bands between 1 kHz and 2 kHz and between 3 kHz and 4 kHz, and causes a knocking sound. “How to Minimize Diesel Combustion Noise by Improving Engine Structure” describes that the engine sound has three peaks at 1.7 kHz, 3.3 kHz, and 6 kHz.

One of these peaks (3.3 kHz) is caused by a stretching resonance of the connecting rod. Specifically, in spring mass models for pistons and connecting rods, the piston, the piston pin, and the smaller end part of the connecting rod correspond to a point mass as a whole, and the coupling part of the connecting rod corresponds to the spring supporting the point mass. Thus, if the piston, the piston pin, and the smaller end part of the connecting rod act integrally, these components integrally resonate with respect to the larger end part of the connecting rod. This resonance corresponds to the stretching resonance of the connecting rod in “How to Minimize Diesel Combustion Noise by Improving Engine Structure.” As one method of suppressing the stretching resonance, the applicants of the present application have applied a technique for providing a dynamic absorber inside a piston pin and, by using the dynamic absorber, suppressing the integral resonance of a piston, the piston pin, and a smaller end part of a connecting rod (JP2012-189134).

On the other hand, as for the vibration in the frequency band between 1 kHz and 2 kHz, the present inventors thought that since in spring mass models for pistons, connecting rods, and crankshafts, the piston, the piston pin, and the connecting rod correspond to a point mass as a whole and stretch between the crankshaft and a larger end part of the connecting rod, then the space between the crankshaft and the larger end part of the connecting rod could be considered to correspond to a spring. However, there has been no countermeasure for such resonance, and furthermore, by improving the stretching resonance (3.3 kHz) of the connecting rod, the resonance in the frequency band of 1 kHz and 2 kHz is considered to stand out, and therefore, a new countermeasure against such resonance is required.

JP2003-525396A discloses a connecting rod structure in which a vibration absorbing member for absorbing vibration between the connecting rod and a crankshaft is provided. That is, a structure is disclosed in which a concaved fit portion is formed in an outer circumferential edge of a crankshaft insertion hole formed in the larger end part of the connecting rod, and an O-ring, which is a vibration attenuating member, is attached to the concaved fit portion.

However, with the structure of JP2003-525396A, although the vibration between the connecting rod and the crankshaft in crankshaft axial directions can be attenuated, the resonance in longitudinal directions of the connecting rod cannot be attenuated.

### SUMMARY

The present invention is made in view of the above situations and provides a connecting rod structure of an engine, which can attenuate vibration in a frequency band between 1 kHz and 2 kHz.

To provide such a connecting rod structure, in the present invention, a dynamic absorber for suppressing a piston, a piston pin, and a connecting rod from integrally resonating with respect to a crankshaft in longitudinal directions of the connecting rod is provided to a larger end part of the connecting rod.

Specifically, according to one aspect of the present invention, a connecting rod structure of an engine with the following configuration is provided.

The connecting rod structure includes a connecting rod for coupling a crankshaft to a piston that reciprocates inside a cylinder, wherein the connecting rod includes a larger end part formed with a shaft insertion hole into which the crankshaft is inserted, a smaller end part formed with a pin insertion hole into which a piston pin for coupling the piston to the smaller end part is inserted, and a coupling part for coupling the larger end part to the smaller end part. The connecting rod structure includes a dynamic absorber provided to the larger end part for suppressing the piston, the piston pin, and the connecting rod from integrally resonating with respect to the crankshaft. The dynamic absorber includes a fixed part fixed to the larger end part, a mass part, and a supporting part for coupling the fixed part to the mass part and supporting the mass part to be movable in substantially longitudinal directions of the connecting rod with respect to the fixed part.

As described above, in the spring mass models for pistons, connecting rods, and crankshafts, the piston, the piston pin, and the connecting rod correspond to a point mass as a whole and stretch between the crankshaft and the large end part of the connecting rod. Therefore, on the basis that the space between the crankshaft and the large end part of the connecting rod is defined to correspond to a spring, by attaching the dynamic absorber at the point mass, when heavy vibration occurs at the point mass, the vibration in the frequency band 1 kHz and 2 kHz can be considered to be attenuatable.

According to the above configuration, the mass part of the dynamic absorber is supported to be movable with respect to the fixed part in substantially the longitudinal directions of the connecting rod. Further, when the piston, the piston pin, and the connecting rod integrally resonate with respect to the crankshaft, the mass part of the dynamic absorber vibrates in the longitudinal directions of the connecting rod in substantially an opposite phase to the piston, the piston pin, and the connecting rod. Therefore, the piston, the piston pin, and the connecting rod can be suppressed from integrally resonating with respect to the crankshaft in the longitudinal directions of the connecting rod. Thus, the vibration at the resonance frequency in the frequency band 1 kHz and 2 kHz can be attenuated.

The dynamic absorber may be integrally provided with the larger end part.

According to this configuration, since the dynamic absorber is integrally provided to the larger end part of the connecting rod, the number of components in this configuration can be reduced, and the arrangement can be simplified.

The dynamic absorber may be provided as a separate body from the larger end part.

According to this configuration, although the vibration attenuation performance of the dynamic absorber is determined based on a spring constant of the supporting part and a mass of the mass part, since the dynamic absorber is provided as a separate body from the larger end part of the connecting rod, these parameters can be set independently from the shape and the like of the connecting rod.

The larger end part may include a main body integrally formed with the coupling part, and a connecting rod cap forming the shaft insertion hole in cooperation with the main body by being fixed to the main body. The fixed part may be fixed to the main body by being fastened to the main body with fastening members for the connecting rod cap.

According to this configuration, in a case where the dynamic absorber is integrally provided to the connecting rod cap, the dynamic absorber and the connecting rod cap can be fixed to the main body. On the other hand, in a case where the dynamic absorber is provided as a separate body from the connecting rod cap, by utilizing the fastening members that are used to fix the connecting rod cap to the main body, the dynamic absorber can be fixed to the main body.

The fixed part may be provided to one side of the connecting rod cap opposite to the coupling part and fixed to the main body together with the connecting rod cap by the fastening members from the side opposite to the coupling part. The mass part may be disposed on the side of the connecting rod cap opposite to the coupling part with a gap therebetween, and may have interference avoiding portions for avoiding interference with the fastening members.

According to this configuration, since the mass part has the interference avoiding portions for avoiding the interference with the fastening members, the fastening members can be brought close to the connecting rod cap on the side of the mass part opposite to the coupling part. Therefore, no space is required for placing the fastening members between the mass part and the fixed part. Thus, the mass part can be brought close to the connecting rod cap side, and the dynamic absorber can be reduced in size. Additionally, since the mass part is brought close to the connecting rod cap, the mass part can accordingly be increased in size and a larger mass can be gained.

Each fastening member may include a bolt. Bolt insertion holes into which the bolts are inserted may be formed in the connecting rod cap and the fixed part to penetrate therethrough. The fixed part may be fixedly pinched by heads of the bolts and the connecting rod cap in a state where shafts of the bolts are inserted through the respective bolt insertion holes of the connecting rod cap and the fixed part, so as to be threadedly engaged to the main body.

According to this configuration, by utilizing the bolts that are used to fix the connecting rod cap to the main body, the dynamic absorber can be fixedly fastened to the main body.

The fixed part may include a pair of fixed parts provided at positions on the side of the larger end part opposite to the coupling part and corresponding to both sides of the larger end part in a direction perpendicular to the longitudinal directions of the connecting rod and perpendicular to the crankshaft. The mass part may be disposed on the side of the larger end part opposite to the coupling part with a gap between the mass part and the larger end part. An outer circumferential edge of a part of the larger end part on the side opposite to the coupling part may be formed into an arc along a contour of the crankshaft. The supporting part may be formed into an arc along the outer circumferential edge of the part of the larger end part on the side opposite to the coupling part. One surface of each of the fixed parts on the larger end part side may be formed into an arc along the supporting part.

According to this configuration, since each surface of the supporting part and the mass part on the coupling part side is formed into the arc along the outer circumferential edge of the larger end part on the side opposite to the coupling part, the supporting part and the mass part can be brought close to the larger end part. Therefore, the dynamic absorber can be reduced in size. Additionally, since the mass part is brought close to the larger end part, the mass part can accordingly be increased in size and a larger mass can be gained.

### BRIEF DESCRIPTION OF THE DRAWINGS

FIG. 1 is a view illustrating a piston and a connecting rod of an engine to which a connecting rod structure according to one embodiment of the present invention is adopted.

FIG. 2 is a cross-sectional view taken along a line II-II in FIG. 1.

FIG. 3 is a cross-sectional view taken along a line III-III in FIG. 1.

FIG. 4 is a view illustrating a spring mass model for the piston and the connecting rod.

FIG. 5 is an enlarged view illustrating the periphery of a connecting rod cap damper in FIG. 1.

FIG. 6A is a perspective view illustrating the connecting rod cap damper seen from a coupling part side of the connecting rod, and FIG. 6B is a perspective view illustrating the connecting rod cap damper seen from a side opposite to the coupling part.

FIG. 7A is a front view illustrating a connecting rod cap damper according to a first modification of the embodiment of the present invention, and FIG. 7B is a perspective view illustrating the connecting rod cap damper according to the first modification seen from a side opposite to a coupling part of a connecting rod.

FIG. 8A is a front view illustrating a connecting rod cap damper according to a second modification of the embodiment of the present invention, FIG. 8B is a view illustrating the connecting rod cap damper according to the second modification seen from a coupling part side of a connecting rod, and FIG. 8C is a view illustrating the connecting rod cap damper according to the second modification seen from a side opposite to the coupling part.

FIG. 9A is a front view illustrating a connecting rod cap damper according to a third modification of the embodiment of the present invention, FIG. 9B is a view illustrating the connecting rod cap damper according to the third modification seen from a coupling part side of a connecting rod, and FIG. 9C is a view illustrating the connecting rod cap damper according to the third modification seen from a side opposite to the coupling part.

FIG. 10A is a front view illustrating a connecting rod cap damper according to a fourth modification of the embodiment of the present invention, FIG. 10B is a view illustrating the connecting rod cap damper according to the fourth modification seen from a coupling part side of a connecting rod, and FIG. 10C is a view illustrating the connecting rod cap damper according to the fourth modification seen from a side opposite to the coupling part.

### DETAILED DESCRIPTION OF EMBODIMENT

Hereinafter, one embodiment of the present invention is described in detail with reference to the appended drawings. Note that, the following description of the preferred embodiment is essentially merely an example, and is not intended to limit the scope, application, or use of the present invention.

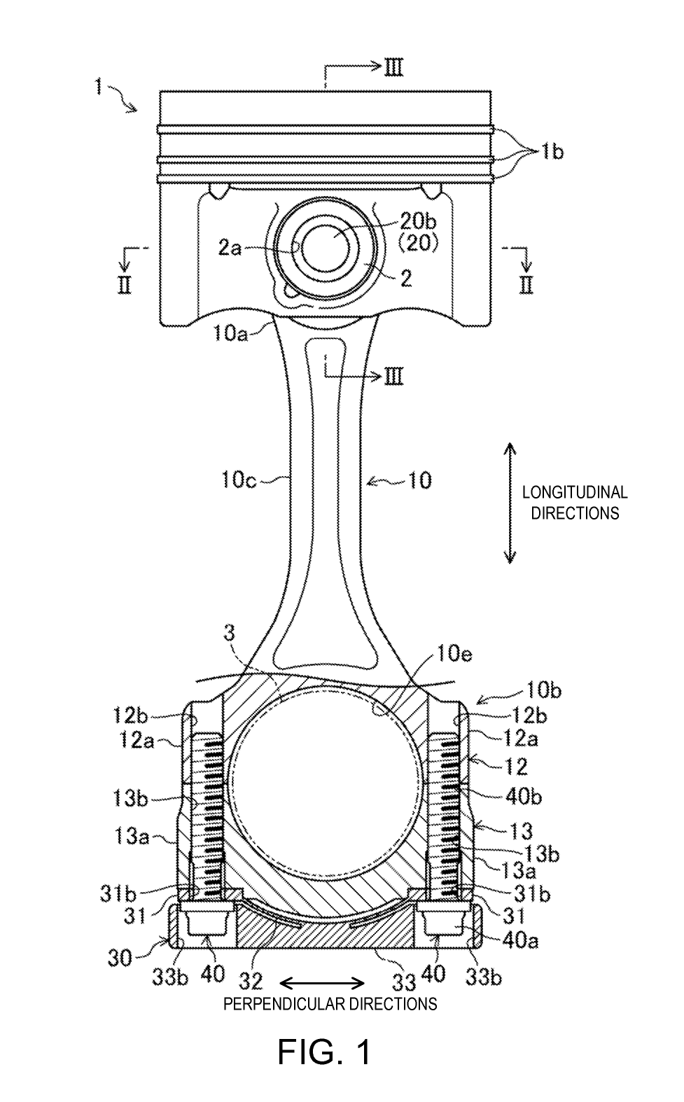

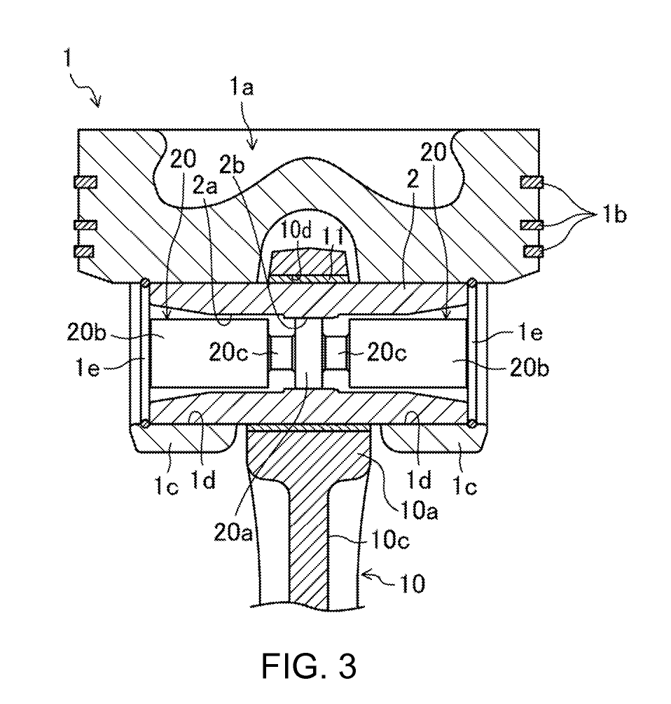

FIGS. 1 to 3 illustrate a piston 1 and a connecting rod 10 of an engine to which a connecting rod structure according to this embodiment of the present invention is adopted. The piston 1 reciprocates in a cylinder in axial directions of the cylinder (up-and-down directions in FIGS. 1 and 3) by repeating a cylinder cycle (intake stroke, compression stroke, combustion stroke (expansion stroke), and exhaust stroke).

The piston 1 is coupled to a smaller end part 10a that is one end part of the connecting rod 10, via a piston pin 2. A larger end part 10b that is the other end part of the connecting rod 10 is coupled to a crankshaft 3 (indicated by the virtual line in FIG. 1). The smaller and larger end parts 10a and 10b of the connecting rod 10 are coupled to each other by a coupling part 10c. The reciprocation of the piston 1 is transmitted to the crankshaft 3 via the connecting rod 10 to rotate the crankshaft 3. Axial directions of the piston pin 2 (left-and-right directions in FIG. 3) match with axial directions of the crankshaft 3. Note that, hereinafter, longitudinal directions of the connecting rod 10 are simply referred to as the “longitudinal directions” and directions perpendicular to the longitudinal directions and the axial directions of the crankshaft 3 are simply referred to as the “perpendicular directions”. Moreover, in FIG. 1, the periphery of the larger end part 10b of the connecting rod 10 is illustrated as a cross-section formed by cutting the periphery with a plane parallel to the perpendicular directions.

The smaller end part 10a of the connecting rod 10 is formed with a pin insertion hole 10d through which the piston pin 2 is inserted, and the larger end part 10b of the connecting rod 10 is formed with a shaft insertion hole 10e through which the crankshaft 3 is inserted.

The piston pin 2 is inserted through the pin insertion hole 10d of the smaller end part 10a of the connecting rod 10, and the smaller end part 10a of the connecting rod 10 is located at a central portion of the piston pin 2 in its axial directions. Moreover, the smaller end part 10a of the connecting rod 10 is located at a central portion of the piston 1 in the axial directions of the piston pin 2.

The piston pin 2 is turnably inserted through the pin insertion hole 10d of the connecting rod 10. Note that, a bush 11 is fixed to an inner circumferential surface of the pin insertion hole 10d of the connecting rod 10, and thus, to be more precise, the piston pin 2 is inserted to be turnable with respect to the bush 11.

A lubricant circulating within the engine is supplied between the piston pin 2 and the pin insertion hole 10d of the connecting rod 10 (specifically, the bush 11) to form a lubricant film, and the lubricant film and the bush 11 enable the piston pin 2 to smoothly turn within the pin insertion hole 10d of the connecting rod 10.

A cavity 1a is formed in a top surface of the piston 1, and a plurality of annular piston rings 1b are fitted onto a part of an outer circumferential surface of the piston 1, at positions closer to the top surface than the piston pin 2 is.

Two boss parts 1c are formed in a back surface of the piston 1 (the surface opposite to the top surface) to bulge toward the crankshaft 3 side, at positions corresponding to both end portions of the piston pin 2 in the axial directions of the piston pin 2 so that the smaller end part 10a of the connecting rod 10 intervenes therebetween. Each of the two boss parts 1c is formed with a pin supporting hole 1d extending in the axial directions of the piston pin 2. Both end portions of the piston pin 2 in the axial directions are supported by being inserted into the pin supporting holes 1d of the two boss parts 1c, respectively.

In this embodiment, a full floating type assembly is adopted for the piston pin 2. Specifically, the piston pin 2 is turnable within the pin insertion hole 10d of the connecting rod 10 and is also turnable within the pin supporting holes 1d of the boss parts 1c of the piston 1.

As are between the piston pin 2 and the pin insertion hole 10d of the connecting rod 10, lubricant films are also formed between the piston pin 2 and each of the pin supporting holes 1d of the boss parts 1c of the piston 1, and these lubricant films enable the piston pin 2 to smoothly turn within the pin supporting holes 1d of the boss parts 1c of the piston 1.

A snap ring 1e is inserted into each of the pin supporting holes 1d of the two boss parts 1c and fixed in one end section of the corresponding pin supporting hole 1d on the outer circumferential surface side of the piston 1. The two snap rings 1e are located to contact with both end surfaces of the piston pin 2 in the axial directions, so as to restrict a movement of the piston pin 2 in the axial directions.

The piston pin 2 is hollow in its cross section, and a through hole 2a extending in the axial directions of the piston pin 2 is formed in a radially central area of the piston pin 2. A press-fit portion 2b into which a fixed part 20a of a pin damper 20 (described later) is press-fitted is formed in an inner circumferential surface of the through hole 2a, in the axially central portion of the piston pin 2. The inner diameter of the through hole 2a at the press-fit portion 2b is smaller than that of the other parts of the through hole 2a.

Inside the piston pin 2 (within the through hole 2a), two pin dampers 20 are provided to suppress the piston 1, the piston pin 2, and the smaller end part 10b of the connecting rod 10 from integrally resonating with respect to the larger end part 10a of the connecting rod 10 during the combustion stroke. The two pin dampers 20 are located on both sides of a plane passing the center of the piston pin 2 in the axial directions (i.e., a plane passing the center and perpendicular to the axis of the piston pin 2).

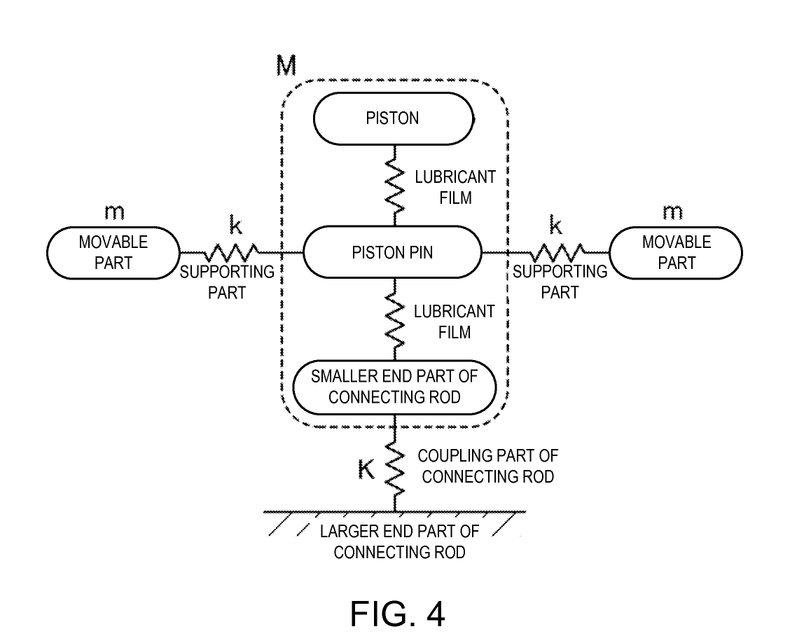

Here, a spring mass model for the piston 1 and the connecting rod 10 is as illustrated in FIG. 4. Specifically, the piston 1, the piston pin 2, and the smaller end part 10a of the connecting rod 10 correspond to a point mass (wherein the mass is M (unit: kg)) as a whole, and the coupling part 10c of the connecting rod 10 corresponds to a spring (wherein the spring constant is K (unit: N/m)) supporting the point mass to the larger end part 10b of the connecting rod 10.

The lubricant film between the piston pin 2 and the pin insertion hole 10d of the connecting rod 10 corresponds to a spring coupling the piston pin 2 to the smaller end part 10a of the connecting rod 10. Moreover, the lubricant films between the piston pin 2 and each of the pin supporting holes 1d of the boss parts 1c of the piston 1 correspond to springs coupling the piston pin 2 to the piston 1 (boss parts 1c).

During the combustion stroke, since the piston 1 is pushed with a strong force, the lubricant film between the piston pin 2 and the pin insertion hole 10d of the connecting rod 10 (the spring coupling the piston pin 2 to the smaller end part 10a of the connecting rod 10) and the lubricant films between the piston pin 2 and each of the pin supporting holes 1d of the boss parts 1c of the piston 1 (the springs coupling the piston pin 2 to the piston 1) are all eliminated, and as a result, the piston 1, the piston pin 2, and the smaller end part 10a of the connecting rod 10 act integrally. Thus, the piston 1, the piston pin 2, and the smaller end part 10a of the connecting rod 10 integrally resonate with respect to the larger end part 10b of the connecting rod 10 at a resonance frequency of (½π)×(K/M)½ Hz.

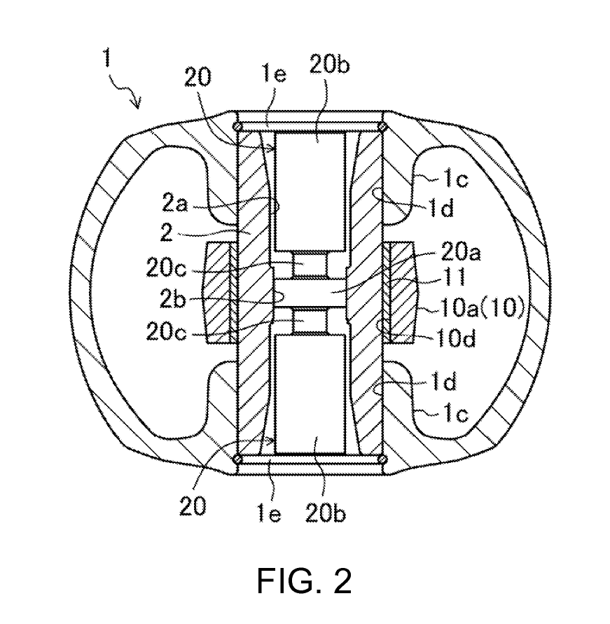

In order to reduce the resonance (reduce the vibration at the resonance frequency), the two pin dampers 20 are provided inside the piston pin 2 (within the through hole 2a). As illustrated in FIGS. 2 and 3, each pin damper 20 includes the fixed part 20a fixed to the press-fit portion 2b formed in the inner circumferential surface of the through hole 2a of the piston pin 2, a movable part 20b extending inside the piston pin 2 in the axial directions of the piston pin 2, and a supporting part 20c for supporting the movable part 20b to be vibratable with respect to the fixed part 20a in the radial directions of the piston pin 2.

In this embodiment, in each pin damper 20, the fixed part 20a, the movable part 20b, and the supporting part 20c are integrally made of metal, and the fixed parts 20a of the two pin dampers 20 are also formed integrally, so that the fixed parts 20a are formed substantially as a single part. The integrally formed fixed parts 20a are fixed by being press-fitted into the press-fit portion 2b and fixed. The movable part 20b of one of the pin dampers 20 is provided, via the corresponding supporting part 20c, on one side surface of the integrally formed fixed parts 20a in the axial directions of the piston pin 2. The movable part 20b of the other pin damper 20 is provided, via the corresponding supporting part 20c, on the other side surface of the integrally formed fixed parts 20a in the axial directions of the piston pin 2.

The movable part 20b of each pin damper 20 is formed into a circular column extending in the axial directions of the piston pin 2. The outer diameter of the movable part 20b is set to a value so as not to contact with the inner circumferential surface of the piston pin 2 even when the movable part 20b vibrates. The supporting part 20c of each pin damper 20 is formed into a circular column so as to couple the movable part 20b to the fixed part 20a of the corresponding pin damper 20. The outer diameter of the supporting part 20c is set to be smaller than that of the movable part 20b, so as to support the movable part 20b to be vibratable in the radial directions of the piston pin 2 with respect to the fixed part 20a. The fixed parts 20a, the movable parts 20b, and the supporting parts 20c of the two pin dampers 20 are positioned concentrically with the piston pin 2. Moreover, the movable parts 20b of the two pin dampers 20 have substantially the same mass, the positions of the center of gravity of the movable parts 20b of the two pin dampers 20 are on a central axis of the piston pin 2 and symmetrical to each other with respect to a plane passing through the center of the piston pin 2 in the axial directions (passing the center and perpendicular to the central axis of the piston pin 2).

Each of the supporting parts 20c of the pin dampers 20 corresponds to a spring supporting the movable part 20b (here, the mass of the movable part 20b is m (unit: kg)), and when the spring constant is k (unit: N/m), in order to reduce the resonance, basically the value of k/m should be made to be substantially the same as that of K/M. The length and diameter of the movable part 20b and the length and diameter of the supporting part 20c are set to obtain such a value of k/m. Technically, the mass of the supporting part 20c needs to be taken into consideration; however, since the mass of the supporting part 20c is significantly smaller than that of the movable part 20b, the mass of the supporting part 20c can be ignored. Note that, in a case where the vibration is allowed to increase at frequencies other than the resonance frequency, the value of k/m does not need to be substantially the same as that of K/M.

It is preferred that the spring constants of the two pin dampers 20 (supporting parts 20c) are made different from each other while having the masses of the movable parts 20b of the two pin dampers 20 substantially the same as each other. This is because, not only the vibration at the resonance frequency, but the vibration in a comparatively wide frequency range including the resonance frequency, can be suppressed by making the spring constants different. To make the spring constants of the two pin dampers 20 different from each other, one or both of the lengths and the diameters of the supporting parts 20c of the two pin dampers 20 may be made different from each other. Alternatively, the materials of the supporting parts 20c of the two pin dampers 20 may be made different. Note that, the spring constants of the two pin dampers 20 may be made substantially the same.

In the case of making the spring constants of the two pin dampers 20 different, for example, the spring constant of one of the pin dampers 20 is set such that the value of k/m becomes substantially the same as that of K/M, and the spring constant of the other pin damper 20 is set to be larger or smaller than the spring constant of the one of the pin dampers 20.

As described above, during the combustion stroke, the lubricant film between the piston pin 2 and the pin insertion hole 10d of the connecting rod 10 (the spring coupling the piston pin 2 to the smaller end part 10a of the connecting rod 10) and the lubricant films between the piston pin 2 and each of the pin supporting holes 1d of the boss parts 1c of the piston 1 (the springs coupling the piston pin 2 to the piston 1) are all eliminated. As a result, the piston 1, the piston pin 2, and the smaller end part 10a of the connecting rod 10 attempt to resonate integrally with respect to the larger end part 10b of the connecting rod 10. However, in this embodiment, the resonance is reduced by the pin dampers 20 provided to the piston pin 2 and, thus, noises caused by the resonance can be reduced.

On the other hand, during the intake stroke, the compression stroke, and the exhaust stroke, the lubricant films respectively exist between the piston pin 2 and the pin insertion hole 10d of the connecting rod 10 and between the piston pin 2 and each of the pin supporting holes 1d of the boss parts 1c of the piston 1. As a result, resonance that is generally caused during the combustion stroke does not occur. If the pin dampers 20 are provided to the smaller end part 10a of the connecting rod 10, the resonance during the combustion stroke can be reduced; however, the pin dampers 20 vibrate during the intake stroke, the compression stroke, and the exhaust stroke where the resonance does not occur. Therefore, during the intake stroke, the compression stroke, and the exhaust stroke, the noises become louder due to the vibration of the pin dampers 20. However, in this embodiment, since the pin dampers 20 are provided to the piston pin 2, during the intake stroke, the compression stroke, and the exhaust stroke, the lubricant film between the piston pin 2 and the pin insertion hole 10d of the connecting rod 10 (the spring coupling the piston pin 2 to the smaller end part 10a of the connecting rod 10) prevents the vibration of the pin dampers 20 from being transmitted to the connecting rod 10, and the noises do not become louder due to the vibration of the pin dampers 20. Moreover, by providing the pin dampers 20 inside the piston pin 2, the space can effectively be utilized and a size increase of the piston 1 is not required.

On the other hand, the larger end part 10b of the connecting rod 10 is divided into two parts at the center of the shaft insertion hole 10e in the longitudinal directions of the coupling part 10c, which are a semicircular main body 12 integrally formed with the coupling part 10c and a semicircular connecting rod cap 13 disposed on a side of the main body 12 opposite to the coupling part 10c. The connecting rod cap 13 constitutes the part of the connecting rod 10 opposite to the coupling part 10c, and an outer circumferential edge of the connecting rod cap 13 is formed into a semicircular arc along the contour of the crankshaft 3. A pair of boss parts 12a and a pair of boss parts 13a are formed on both sides of the main body 12 and both sides of the connecting rod cap 13 in the perpendicular directions, respectively. The boss parts 12a and 13a extend substantially in the longitudinal directions of the connecting rod 10. A bolt hole 12b is formed in each of the boss parts 12a of the main body 12 and formed with a female thread. A bolt 40 (fastening member) for being inserted through a bolt insertion hole 13b formed in each boss part 13a of the connecting rod cap 13 is threadedly engaged into each bolt hole 12b so as to integrate the main body 12 with the connecting rod cap 13.

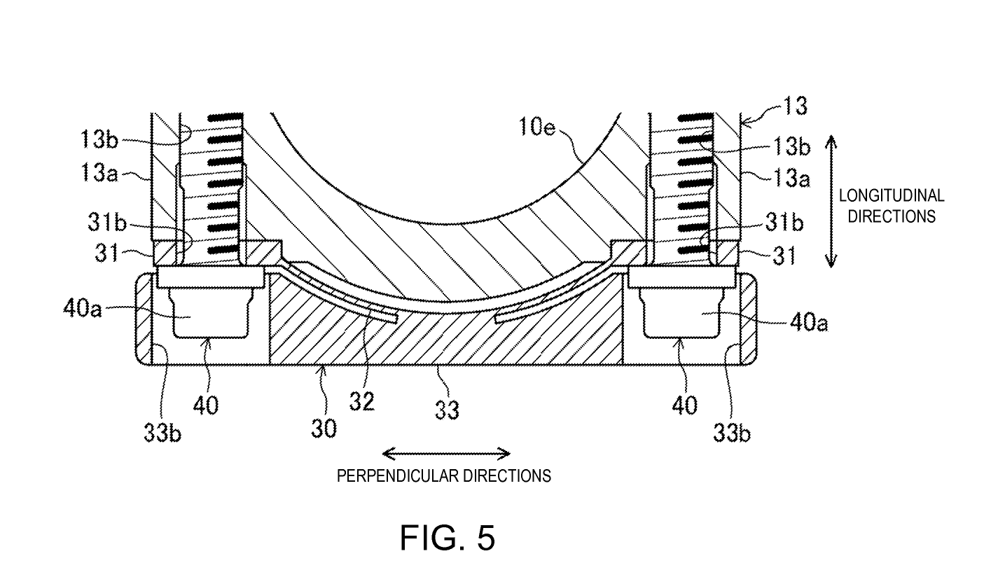

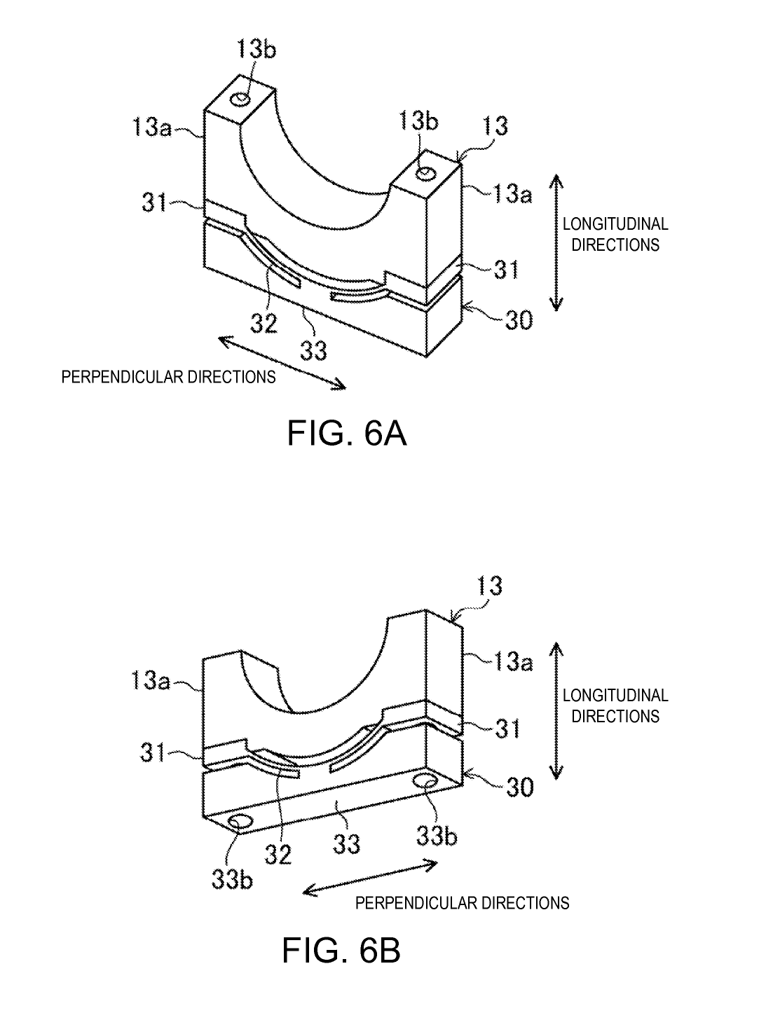

A connecting rod cap damper 30 (dynamic absorber) for suppressing the piston 1, the piston pin 2, and the connecting rod 10 from integrally resonating with respect to the crankshaft is disposed to an outer circumference of the connecting rod cap 13, as a separate body from the connecting rod cap 13. FIG. 5 is a view illustrating the periphery of the connecting rod cap damper 30 in FIG. 1, in an enlarged manner. FIG. 6A is a perspective view illustrating the connecting rod cap damper 30 seen from the coupling part 10c side of the connecting rod 10, and FIG. 6B is a perspective view illustrating the connecting rod cap damper 30 seen from the opposite side to the coupling part 10c.

Here, in the spring mass model for the piston 1, the connecting rod 10, and the crankshaft 3, the piston 1, the piston pin 2, and the connecting rod 10 correspond to a point mass as a whole, the crankshaft and the larger end part of the connecting rod stretch therebetween, and the crankshaft and the larger end part of the connecting rod correspond to a spring at therebetween. Furthermore, the piston 1, the piston pin 2, and the connecting rod 10 integrally resonate with respect to the crankshaft 3 in the longitudinal directions of the connecting rod 10.

To reduce the resonance (reduce the vibration caused at the resonance frequency), the connecting rod cap damper 30 is provided to the connecting rod cap 13. The connecting rod cap damper 30 has a pair of fixed parts 31, a supporting part 32, and a mass part 33. Each fixed part 31 is fixed to one surface of the corresponding boss part 13a on the side opposite to the coupling part 10c. The supporting part 32 couples the fixed parts 31 together on the outer circumferential side of the connecting rod cap 13. The mass part 33 is coupled to one end of the supporting part 32 on the side opposite to the coupling part 10c. The mass part 33, the fixed parts 31, and the supporting part 32 are integrally made of metal.

Each fixed part 31 is formed into a flat plate, and a bolt insertion hole 31b coaxial with the bolt insertion hole 13b formed in the boss parts 13a of the connecting rod cap 13 is formed to penetrate substantially the center of the fixed part 31. Further, the fixed parts 31 and the connecting rod cap 13 are co-fastened to the main body 12 by the bolts 40. Specifically, each bolt insertion hole 31b of the fixed part 31 is formed to have a smaller diameter than a head 40a of the bolt 40, and the fixed part 31 is pinched to be fixed by the head 40a of the bolt 40 and the boss part 13a of the connecting rod cap 13 in a state where a shaft 40b of the bolt 40 is inserted through the bolt insertion hole 31b of the fixed part 31 from the side opposite to the coupling part 10c so as to be threadedly engaged into the bolt hole 12b formed in the main body 12. As described above, the connecting rod cap damper 30 is fixedly fastened to the main body 12 by utilizing the bolts 40 which are for fixing the connecting rod cap 13 to the main body 12.

The supporting part 32 is formed by a thinner plate than the fixed parts 31, into an arc along the outer circumferential edge of the connecting rod cap 13, on the outer circumferential side of the connecting rod cap 13. Therefore, the supporting part 32 can elastically deform in the longitudinal directions of the connecting rod 10. Thus, the supporting part 32 can support the mass part 33 coupled to its end opposite to the coupling part 10c side to be movable in the longitudinal directions of the connecting rod 10. Further, since the supporting part 32 is formed into the arc along the outer circumferential edge of the connecting rod cap 13 as described above, it can be brought close to the connecting rod cap 13.

Moreover, the supporting part 32 corresponds to a spring for supporting the mass part 33, and a length and thickness of the supporting part 32 are set so as to reduce the resonance. Technically, the mass of the supporting part 32 needs to be taken into consideration; however, since the mass of the supporting part 32 is significantly smaller than that of the mass part 33, the mass of the supporting part 32 can be ignored.

The mass part 33 is coupled to the end of the supporting part 32 opposite to the coupling part 10c side as described above. In other words, the mass part 33 is disposed on the side of the connecting rod cap 13 opposite to the coupling part 10c, with a gap from the connecting rod cap 13.

The mass part 33 has substantially the same width with the larger end part 10b of the connecting rod 10 and is formed into a thicker plate than the fixed part 31. The mass of the mass part 33 is set in consideration of the spring constant of the supporting part 32, so as to suppress the integral resonance of the piston 1, the piston pin 2, and the connecting rod 10.

Moreover, bolt insertion holes 33b (interference avoiding portions) coaxial with the bolt insertion holes 13b formed in the boss parts 13a of the connecting rod cap 13 are formed to penetrate the mass part 33. Each bolt insertion hole 33b is formed to have a larger diameter than the head 40a of the bolt 40. Therefore, when the bolts 40 are inserted into the bolt insertion holes 33b of the mass part 33 from the side opposite to the coupling part 10c to fixedly fasten the connecting rod cap damper 30 to the main body 12, each bolt 40 can penetrate the mass part 33 without interfering with the mass part 33.

Further, while the surface of the mass part 33 on the opposite side to the coupling part 10c extends in the perpendicular directions, the surface of the mass part 33 on the coupling part 10c side extends along the supporting part 32, in other words, it is formed into an arc along the outer circumferential edge of the connecting rod cap 13. Therefore, the mass part 33 can be brought close to the connecting rod cap 13, similar to the supporting part 32. Thus, the connecting rod cap damper 30 can be reduced in size.

Furthermore, as described above, the connecting rod 10 attempts to resonate with respect to the crankshaft 3 in the longitudinal directions of the connecting rod 10, integrally with the piston 1 and the piston pin 2. However, in this embodiment, the mass part 33 of the connecting rod cap damper 30 provided to the connecting rod cap 13 vibrates in the longitudinal directions of the connecting rod 10 in an opposite phase to the connecting rod 10 while being supported by the supporting part 32, and thus, the resonance described above is reduced and noise caused by the resonance can be reduced.

### Effects of this Embodiment of the Present Invention

According to this embodiment, the mass part 33 of the connecting rod cap damper 30 is supported against the fixed parts 31 to be movable substantially in the longitudinal directions of the connecting rod 10. Further, when the piston 1, the piston pin 2, and the connecting rod 10 integrally resonate with respect to the crankshaft 3, the mass part 33 of the connecting rod cap damper 30 vibrates substantially in the longitudinal directions of the connecting rod 10, substantially in the opposite phase to the piston 1, the piston pin 2, and the connecting rod 10. Therefore, the integral resonance of the piston 1, the piston pin 2, and the connecting rod 10 in the longitudinal directions of the connecting rod 10 can be reduced. Thus, the resonance in a frequency band between 1 kHz and 2 kHz, which conventionally occurs, can be attenuated.

Moreover, according to this embodiment, although the vibration attenuation performance of the connecting rod cap damper 30 is determined based on the spring constant of the supporting part 32 of the connecting rod cap damper 30 and the mass of the mass part 33, since the connecting rod cap damper 30 is provided as a separate body from the larger end part 10b of the connecting rod 10, these parameters can be set independently from the shape and the like of the connecting rod 10.

Furthermore, according to this embodiment, the connecting rod cap damper 30 is provided as a separate body from the connecting rod cap 13 and, by utilizing the bolts 40 which are used to fix the connecting rod cap 13 to the main body 12 of the larger end part 10b, the connecting rod cap damper 30 can be fixedly fastened to the main body 12 of the larger end part 10b.

Further, according to this embodiment, since the mass part 33 of the connecting rod cap damper 30 is formed with the bolt insertion holes 33b for avoiding the interference with the bolts 40, the bolts 40 can be inserted into the bolt insertion holes 33b of the mass part 33 from the side of the mass part 33 of the connecting rod cap damper 30 opposite to the coupling part 10c. Therefore, no space for the bolts 40 to be placed between the mass part 33 of the connecting rod cap damper 30 and the fixed parts 31 is required. Thus, the mass part 33 of the connecting rod cap damper 30 can be brought close to the connecting rod cap 13 side, and the connecting rod cap damper 30 can be reduced in size. Additionally, since the mass part 33 of the connecting rod cap damper 30 is brought close to the connecting rod cap 13, the mass part 33 can accordingly be increased in size and a larger mass can be gained.

Furthermore, according to this embodiment, since each of the surfaces of the supporting part 32 and the mass part 33 of the connecting rod cap damper 30 on the coupling part 10c side of the connecting rod 10 is formed into the arc along the outer circumferential edge of the larger end part 10b on the opposite side to the coupling part 10c, the supporting part 32 and the mass part 33 can be brought close to the larger end part 10b of the connecting rod 10. Therefore, the connecting rod cap damper 30 can be reduced in size. Additionally, since the mass part 33 of the connecting rod cap damper 30 is brought close to the larger end part 10b of the connecting rod 10, the mass part 33 can accordingly be increased in size and a larger mass can be gained.

### First Modification

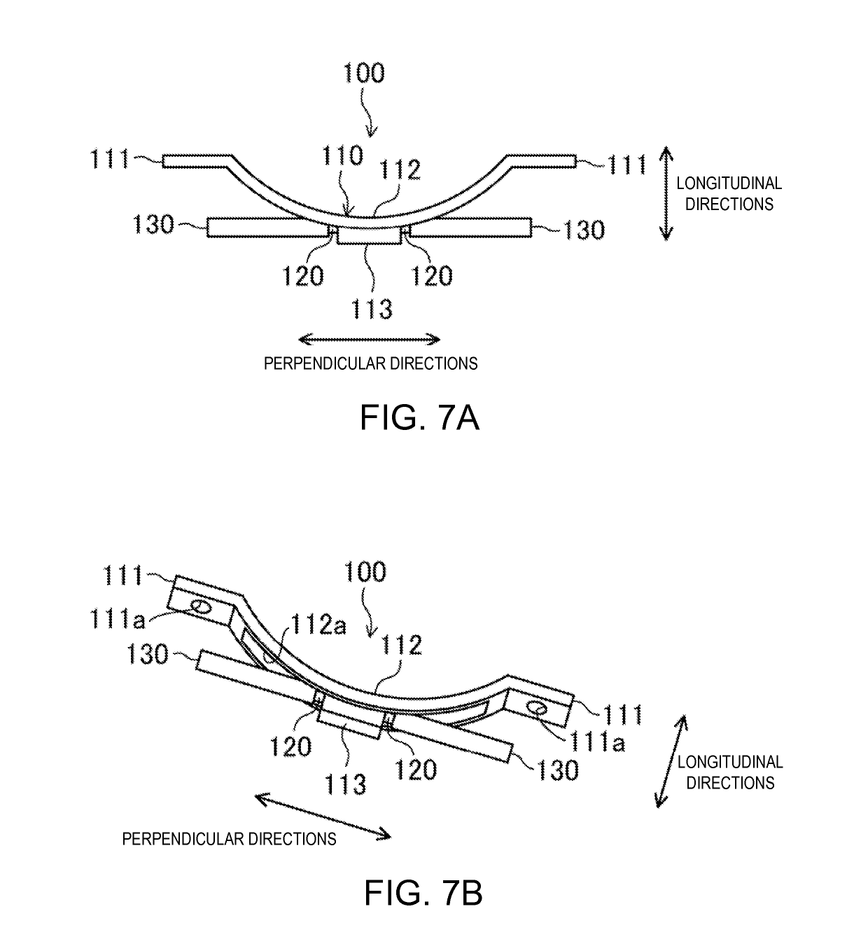

FIG. 7A is a front view illustrating a connecting rod cap damper 100 (dynamic absorber) according to a first modification of the embodiment of the present invention, and FIG. 7B is a perspective view illustrating the connecting rod cap damper 100 according to the first modification seen from the side opposite to the coupling part 10c of the connecting rod 10.

A fixed part 110 of the connecting rod cap damper 100 includes a pair of fastening portions 111 respectively to be fixedly fastened, by the bolts 40, to the surfaces of the boss parts 13a of the connecting rod cap 13 opposite to the coupling part 10c side, and a bridging portion 112 extending between the pair of fastening portions 111 while forming an arc along the outer circumferential edge of the connecting rod cap 13, and bridging between both fastening portions 111. Each fastening portion 111 is formed with a bolt insertion hole 111a to penetrate therethrough. On the other hand, the bridging portion 112 is formed with a rectangular through hole 112a extending in the perpendicular directions described above. A holder 113 for holding a pair of supporting parts 120 disposed on both sides of the holder 113 in the perpendicular directions is provided in a central section of the through hole 112a, at one end of the through hole 112a opposite to the coupling part 10c side in the longitudinal directions of the connecting rod 10. Each supporting part 120 is formed into a circular column and extends outward from the holder 113 in the perpendicular directions. Mass parts 130, each formed by a circular column member having a larger diameter than the corresponding supporting part 120, are fixed to tips of the supporting parts 120, respectively. The connecting rod cap damper 100 is fixed to the connecting rod cap 13 in a state where both fastening portions 111 are fixedly fastened to the boss parts 13a of the connecting rod cap 13 and the bridging portion 112 is in close contact with the connecting rod cap 13.

Further, if the piston 1, the piston pin 2, and the connecting rod 10 attempt to integrally resonate with respect to the crankshaft 3, the mass parts 130 vibrate to reduce the resonance.

### Second Modification

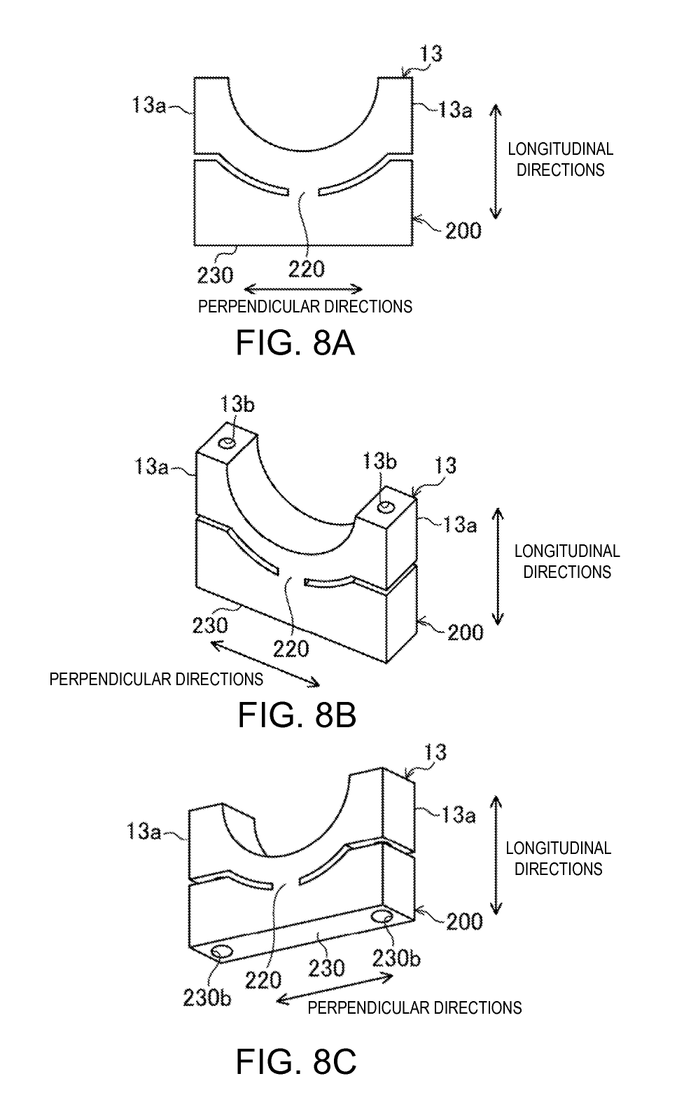

FIG. 8A is a front view illustrating a connecting rod cap damper 200 (dynamic absorber) according to a second modification of the embodiment of the present invention, FIG. 8B is a view illustrating the connecting rod cap damper 200 according to the second modification seen from the coupling part 10c side of the connecting rod 10, and FIG. 8C is a view illustrating the connecting rod cap damper 200 according to the second modification seen from the side opposite to the coupling part 10c.

The connecting rod cap damper 200 is different from the connecting rod cap damper 30 of this embodiment in that the connecting rod cap damper 200 is integrally provided with the connecting rod cap 13.

That is, a fixed part of the connecting rod cap damper 200 is integrated with an outer circumferential edge part of the connecting rod cap 13. In other words, the outer circumferential edge part of the connecting rod cap 13 substantially constitutes the fixed part of the connecting rod cap damper 200. Further, a supporting part 220 extends in the longitudinal directions from one end of the outer circumferential edge part opposite to the coupling part 10c side, and a mass part 230 is provided to a tip of the supporting part 220. The mass part 230 has substantially the same shape as the mass part 33 of the connecting rod cap damper 30 of this embodiment, and a surface thereof on the coupling part 10c side is formed into an arc along the outer circumferential edge of the connecting rod cap 13. Therefore, the mass part 230 can be brought close to the connecting rod cap 13 and can a larger mass can be gained. Moreover, bolt insertion holes 230b coaxial with the bolt insertion holes 13b formed in the boss parts 13a of the connecting rod cap 13 are formed in both end portions of the mass part 230, respectively.

Thus, according to this modification, since the connecting rod cap damper 200 is integrally provided with the connecting rod cap 13, the number of components can be reduced, the configuration can be simplified, and the connecting rod cap damper 200 can be fixed to the main body 12 at the same time that the connecting rod cap 13 is fixed to the main body 12 of the larger end part 10b of the connecting rod 10.

### Third Modification

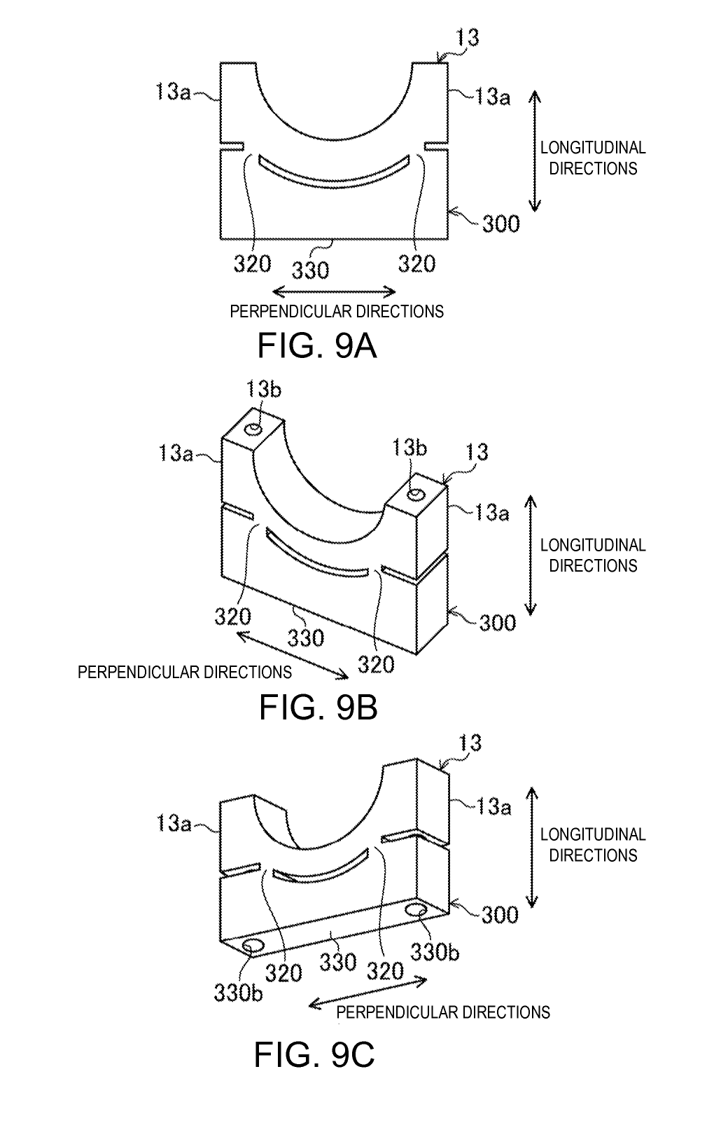

FIG. 9A is a front view illustrating a connecting rod cap damper 300 (dynamic absorber) according to a third modification of the embodiment of the present invention, FIG. 9B is a view illustrating the connecting rod cap damper 300 according to the third modification seen from the coupling part 10c side of the connecting rod 10, and FIG. 9C is a view illustrating the connecting rod cap damper 300 according to the third modification seen from the side opposite to the coupling part 10c.

The connecting rod cap damper 300 is different from the connecting rod cap damper 200 of the second modification in that the connecting rod cap damper 300 includes a pair of supporting parts 320. That is, the pair of supporting parts 320 supports a mass part 330 at both its end portions in the perpendicular directions. Specifically, each supporting part 320 is provided at a position further inward than the bolt insertion holes 330b of the mass part 330 in the perpendicular directions.

Since the mass part 330 is supported by the pair of supporting parts 320 as above, the durability improves compared to that of the connecting rod cap damper 200 of the second modification which supports the mass part 230 by the single supporting part 220.

### Fourth Modification

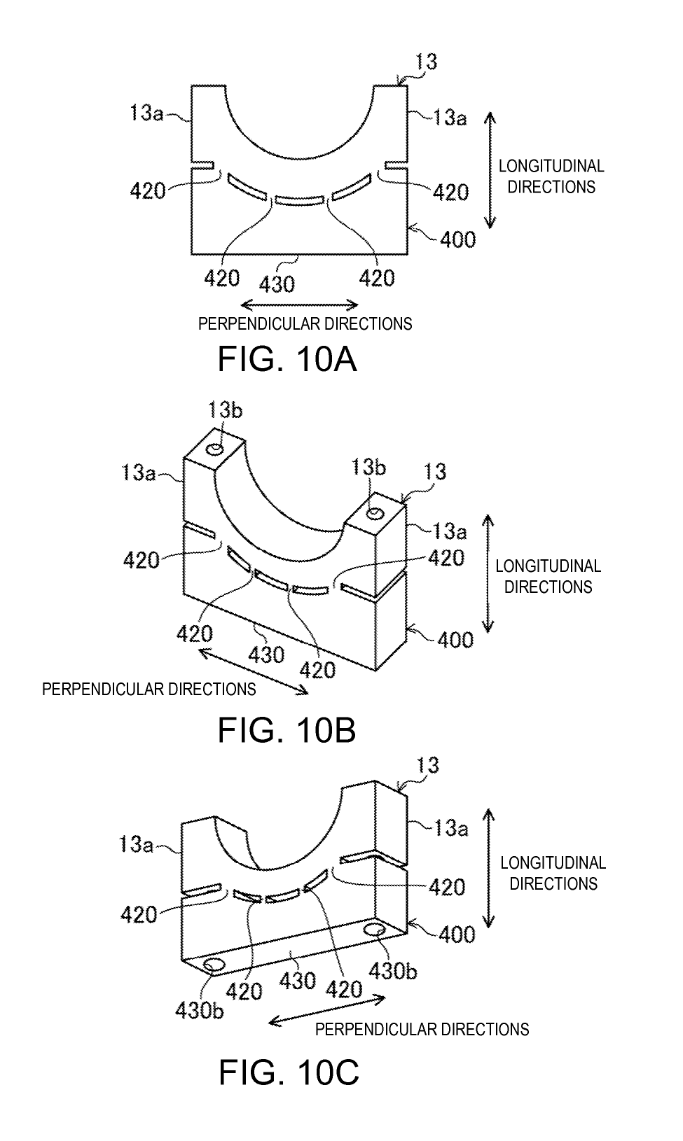

FIG. 10A is a front view illustrating a connecting rod cap damper 400 (dynamic absorber) according to a fourth modification of the embodiment of the present invention, FIG. 10B is a view illustrating the connecting rod cap damper 400 according to the fourth modification seen from the coupling part 10c side of the connecting rod 10, and FIG. 10C is a view illustrating the connecting rod cap damper 400 according to the fourth modification seen from the side opposite to the coupling part 10c.

The connecting rod cap damper 400 is different from the connecting rod cap damper 300 of the third modification in a configuration of a supporting part 420. That is, the supporting part 420 supports a mass part 430 at four positions. Specifically, the supporting part 420 is provided at both end portions of the mass part 430 in the perpendicular directions, further inward than the bolt insertion holes 430b of the mass part 430 in the perpendicular directions. The supporting parts 420 also include a pair of supporting parts 420 provided in a central portion of the mass part 430 in the perpendicular directions, with a gap therebetween in the perpendicular directions.

Since the mass part 430 is supported at the four positions as above, the durability improves compared to that of the connecting rod cap damper 300 of the third modification.

As described above, the connecting rod structure of the engine according to the present invention is applicable to cases of attenuating vibration in the frequency band between 1 kHz and 2 kHz.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

1 Piston
2 Piston Pin
3 Crankshaft
10 Connecting Rod
10a Smaller End Part of Connecting Rod
10b Larger End Part of Connecting Rod
10c Coupling Part of Connecting Rod
10d Pin Insertion Hole
10e Shaft Insertion Hole
12 Main Body
13 Connecting Rod Cap
30, 100, 200, 300, 400 Connecting Rod Cap Damper (Dynamic Absorber)
31, 110 Fixed Part
32, 120, 220, 420 Supporting Part
33, 130, 230, 430 Mass Part
40 Bolt (Fastening Member)
40a Head of Bolt
40b Shaft of Bolt

What is claimed is:

1. A connecting rod structure of an engine, comprising:
a connecting rod for coupling a crankshaft to a piston that reciprocates inside a cylinder, the connecting rod including a larger end part formed with a shaft insertion hole into which the crankshaft is inserted, a smaller end part formed with a pin insertion hole into which a piston pin for coupling the piston to the smaller end part is inserted, and a coupling part for coupling the larger end part to the smaller end part; and
a dynamic absorber provided to the larger end part for suppressing the piston, the piston pin, and the connecting rod from integrally resonating with respect to the crankshaft,
wherein the dynamic absorber includes a fixed part fixed to the larger end part, a mass part, and a supporting part for coupling the fixed part to the mass part and supporting the mass part to be movable in substantially longitudinal directions of the connecting rod with respect to the fixed part.

2. The connecting rod structure of claim 1, wherein the dynamic absorber is integrally provided with the larger end part.

3. The connecting rod structure of claim 1, wherein the dynamic absorber is provided as a separate body from the larger end part.

4. The connecting rod structure of claim 1, wherein the larger end part includes a main body integrally formed with the coupling part, and a connecting rod cap forming the shaft insertion hole in cooperation with the main body by being fixed to the main body, and
wherein the fixed part is fixed to the main body by being fastened to the main body with fastening members for the connecting rod cap.

5. The connecting rod structure of claim 2, wherein the larger end part includes a main body integrally formed with the coupling part, and a connecting rod cap forming the shaft insertion hole in cooperation with the main body by being fixed to the main body, and
wherein the fixed part is fixed to the main body by being fastened to the main body with fastening members for the connecting rod cap.

6. The connecting rod structure of claim 3, wherein the larger end part includes a main body integrally formed with the coupling part, and a connecting rod cap forming the shaft insertion hole in cooperation with the main body by being fixed to the main body, and
wherein the fixed part is fixed to the main body by being fastened to the main body with fastening members for the connecting rod cap.

7. The connecting rod structure of claim 4, wherein the fixed part is provided to one side of the connecting rod cap opposite to the coupling part and is fixed to the main body together with the connecting rod cap by the fastening members from the side opposite to the coupling part, and
wherein the mass part is disposed on the side of the connecting rod cap opposite to the coupling part with a gap therebetween, and has interference avoiding portions for avoiding interference with the fastening members.

8. The connecting rod structure of claim 5, wherein the fixed part is provided to one side of the connecting rod cap opposite to the coupling part and is fixed to the main body together with the connecting rod cap by the fastening members from the side opposite to the coupling part, and
wherein the mass part is disposed on the side of the connecting rod cap opposite to the coupling part with a gap therebetween, and has interference avoiding portions for avoiding interference with the fastening members.

9. The connecting rod structure of claim 6, wherein the fixed part is provided to one side of the connecting rod cap opposite to the coupling part and is fixed to the main body together with the connecting rod cap by the fastening members from the side opposite to the coupling part, and
wherein the mass part is disposed on the side of the connecting rod cap opposite to the coupling part with a gap therebetween, and has interference avoiding portions for avoiding interference with the fastening members.

10. The connecting rod structure of claim 4, wherein each fastening member includes a bolt,
wherein bolt insertion holes into which the bolts are inserted are formed in the connecting rod cap and the fixed part to penetrate therethrough, and
wherein the fixed part is fixedly pinched between heads of the bolts and the connecting rod cap in a state where shafts of the bolts are inserted through the respective bolt insertion holes of the connecting rod cap and the fixed part, so as to be threadedly engaged to the main body.

11. The connecting rod structure of claim 5, wherein each fastening member includes a bolt,
wherein bolt insertion holes into which the bolts are inserted are formed in the connecting rod cap and the fixed part to penetrate therethrough, and
wherein the fixed part is fixedly pinched between heads of the bolts and the connecting rod cap in a state where shafts of the bolts are inserted through the respective bolt insertion holes of the connecting rod cap and the fixed part, so as to be threadedly engaged to the main body.

12. The connecting rod structure of claim 6, wherein each fastening member includes a bolt,
wherein bolt insertion holes into which the bolts are inserted are formed in the connecting rod cap and the fixed part to penetrate therethrough, and
wherein the fixed part is fixedly pinched between heads of the bolts and the connecting rod cap in a state where shafts of the bolts are inserted through the respective bolt insertion holes of the connecting rod cap and the fixed part, so as to be threadedly engaged to the main body.

13. The connecting rod structure of claim 7, wherein each fastening member includes a bolt,
wherein bolt insertion holes into which the bolts are inserted are formed in the connecting rod cap and the fixed part to penetrate therethrough, and
wherein the fixed part fixedly pinched between the bolts and the connecting rod cap in a state where shafts of the bolts are inserted through the respective bolt insertion holes of the connecting rod cap and the fixed part, so as to be threadedly engaged to the main body.

14. The connecting rod structure of claim 8, wherein each fastening member includes a bolt,
wherein bolt insertion holes into which the bolts are inserted are formed in the connecting rod cap and the fixed part to penetrate therethrough, and
wherein the fixed part is fixedly pinched between the bolts and the connecting rod cap in a state where shafts of the bolts are inserted through the respective bolt insertion holes of the connecting rod cap and the fixed part, so as to be threadedly engaged to the main body.

15. The connecting rod structure of claim 9, wherein each fastening member includes a bolt,
wherein bolt insertion holes into which the bolts are inserted are formed in the connecting rod cap and the fixed part to penetrate therethrough, and
wherein the fixed part is fixedly pinched between the bolts and the connecting rod cap in a state where shafts of the bolts are inserted through the respective bolt insertion holes of the connecting rod cap and the fixed part, so as to be threadedly engaged to the main body.

16. The connecting rod structure of claim 1, wherein the fixed part includes a pair of fixed parts provided on a side of the larger end part opposite to the coupling part, at positions on both sides of the larger end part in a direction perpendicular to the longitudinal directions of the connecting rod and perpendicular to the crankshaft,
wherein the mass part is disposed on the side of the larger end part opposite to the coupling part with a gap between the mass part and the larger end part,
wherein an outer circumferential edge of a part of the larger end part on the side opposite to the coupling part is formed into an arc along a contour of the crankshaft,
wherein the supporting part is formed into an arc along the outer circumferential edge of the part of the larger end part on the side opposite to the coupling part, and
wherein one surface of each of the fixed parts on the larger end part side is formed into an arc along the supporting part.

17. The connecting rod structure of claim 2, wherein the fixed part includes a pair of fixed parts provided on a side of the larger end part opposite to the coupling part, at positions on both sides of the larger end part in a direction perpendicular to the longitudinal directions of the connecting rod and perpendicular to the crankshaft,
wherein the mass part is disposed on the side of the larger end part opposite to the coupling part with a gap between the mass part and the larger end part,
wherein an outer circumferential edge of a part of the larger end part on the side opposite to the coupling part is formed into an arc along a contour of the crankshaft,
wherein the supporting part is formed into an arc along the outer circumferential edge of the part of the larger end part on the side opposite to the coupling part, and
wherein one surface of each of the fixed parts on the larger end part side is formed into an arc along the supporting part.

18. The connecting rod structure of claim 3, wherein the fixed part includes a pair of fixed parts provided on a side of the larger end part opposite to the coupling part, at positions on both sides of the larger end part in a direction perpendicular to the longitudinal directions of the connecting rod and perpendicular to the crankshaft,
wherein the mass part is disposed on the side of the larger end part opposite to the coupling part with a gap between the mass part and the larger end part,
wherein an outer circumferential edge of a part of the larger end part on the side opposite to the coupling part is formed into an arc along a contour of the crankshaft,
wherein the supporting part is formed into an arc along the outer circumferential edge of the part of the larger end part on the side opposite to the coupling part, and
wherein one surface of each of the fixed parts on the larger end part side is formed into an arc along the supporting part.

19. The connecting rod structure of claim 4, wherein the fixed part includes a pair of fixed parts provided on a side of the larger end part opposite to the coupling part, at positions on both sides of the larger end part in a direction perpendicular to the longitudinal directions of the connecting rod and perpendicular to the crankshaft,
wherein the mass part is disposed on the side of the larger end part opposite to the coupling part with a gap between the mass part and the larger end part,
wherein an outer circumferential edge of a part of the larger end part on the side opposite to the coupling part is formed into an arc along a contour of the crankshaft,
wherein the supporting part is formed into an arc along the outer circumferential edge of the part of the larger end part on the side opposite to the coupling part, and
wherein one surface of each of the fixed parts on the larger end part side is formed into an arc along the supporting part.

20. The connecting rod structure of claim 5, wherein the fixed part includes a pair of fixed parts provided on a side of the larger end part opposite to the coupling part, at positions on both sides of the larger end part in a direction perpendicular to the longitudinal directions of the connecting rod and perpendicular to the crankshaft,
wherein the mass part is disposed on the side of the larger end part opposite to the coupling part with a gap between the mass part and the larger end part,
wherein an outer circumferential edge of a part of the larger end part on the side opposite to the coupling part is formed into an arc along a contour of the crankshaft,
wherein the supporting part is formed into an arc along the outer circumferential edge of the part of the larger end part on the side opposite to the coupling part, and
wherein one surface of each of the fixed parts on the larger end part side is formed into an arc along the supporting part.
